(19) United States
(12) Patent Application Publication
(10) Pub. No.: US 2026/0333084 A1
(43) Pub. Date: Oct. 22, 2026

(54) WIRELESS NETWORK MONITORING USING UAVS

(71) Applicant: BRITISH TELECOMMUNICATIONS PUBLIC LIMITED COMPANY, London, Greater London (GB)

(72) Inventors: Jonathan ROSCOE, London (GB); Behnam AZVINE, London (GB)

(21) Appl. No.: 19/115,015

(22) PCT Filed: Sep. 7, 2023
(86) PCT No.: PCT/EP2023/074640

§ 371 Date: Mar. 25, 2025

(30) Foreign Application Priority Data
Sep. 28, 2022 (EP) 22198431.3
Sep. 28, 2022 (GB) 2214186.5

(51) Int. Cl. H04W 24/08; G05D 1/689; G05D 105/80; H04B 7/185; H04W 60/00

(52) U.S. Cl. CPC H04W 24/08; G05D 1/689; H04B 7/18504; H04W 60/00; G05D 2105/80

(57) ABSTRACT

An Unmanned Aerial Vehicle, UAV, configurable to: incidentally collect wireless network data at a first level of detail; send the wireless network data to a controller; in response to receiving an instruction from the controller, collect wireless network data from the wireless network device at a second level of detail higher than the first level of detail; and send the wireless network data at the second level of detail to the controller.

### CROSS-REFERENCE TO RELATED APPLICATIONS

This application is the U.S. national phase of International Application No. PCT/EP2023/074640 filed Sep. 7, 2023, which designated the U.S. and claims priority to EP Patent Application No. 22198431.3 filed Sep. 28, 2022, and GB Patent Application No. 2214186.5 filed Sep. 28, 2022, the entire contents of each of which are hereby incorporated by reference.

### FIELD OF INVENTION

The present invention relates to collecting data for monitoring wireless network devices using Unmanned Aerial Vehicles (UAVs).

### BACKGROUND

Wireless networking devices are susceptible to a range of vulnerabilities in the wireless domain. These vulnerabilities cause compromised security for the device and the wider network. Vulnerabilities in the wireless domain are not always detectable through the wired network and may require on site monitoring of wireless communication activity.

An example of a wireless networking device is a Wireless Access Point (WAP). WAPs offer outward facing ports to allow external devices to connect with the WAP and potentially a connected network of other devices through different protocols. The ports may be open allowing any device to access, filtered providing restricted access or closed providing no access. Unexpected open ports are a security flaw which could allow malicious actors access into a private network.

The wireless domain is traditionally monitored using ground based wireless network equipment with applications such as a port scanner. However, the locations and distances between networking devices and the stochastic occurrence of new vulnerabilities and compromises can make this approach inconvenient and ineffective.

### SUMMARY

According to a first aspect of the present invention, there is provided a method performed by a controller of a plurality of Unmanned Aerial Vehicles, UAVs, for wireless network monitoring that comprises receiving wireless network data from one or more UAVs at a first level of detail; determining whether the wireless network data indicates an irregularity in a wireless network device; and in response to determining there is an indicated irregularity in the wireless network device, instructing one or more additional UAVs to collect wireless network data from the wireless network device at a second level of detail that is higher than the first level of detail.

Preferably the method further comprises receiving from the one or more UAVs a location of the wireless network device and updating route-planning of the one or more additional UAVs to include the location.

Preferably the wireless network data at the first level of detail comprises one or more of: RF frequency data and handshake session data.

Preferably the wireless network data at the second level of detail comprises one or more of: latency test data and configuration check data. Preferably the configuration check data comprises one or more of Domain Name Service, DNS, Dynamic Host Configuration Protocol, DHCP, and firewall check data.

Preferably the method further comprises receiving from the one or more additional UAVs the wireless network data at the second level of detail; determining whether the wireless network data at the second level of detail indicates a vulnerability in the wireless network device; and in response to determining there is an indicated vulnerability in the wireless network, instructing one or more further additional UAVs to collect wireless network data from the wireless network device at a third level of detail that is higher than the first and second level of detail, the wireless network data at the third level of detail comprising at least one of port scan data and Common Vulnerabilities Exploits, CVE, detection data.

Preferably the method further comprising receiving from the one or more further additional UAVs the wireless network data at the third level of detail; and communicating with the wireless network device to take remedial action based at least in part on the wireless network data at the third level of detail.

Preferably the method further comprises retrieving a baseline model for the wireless network data; and wherein the determining whether the wireless network data indicates an irregularity in the wireless network device comprises comparing the wireless network data at the first level of detail to the baseline model for the wireless network data.

Preferably the method further comprising determining whether the wireless network data indicates an irregularity in the wireless network device comprises classifying the wireless network data using a trained classifier; the classifier being trained using examples, previously collected using at least one UAV, of wireless network data from known vulnerable wireless network devices; and the classifier generating a likelihood that the wireless network device is vulnerable.

Preferably the one or more UAVs are the same as the one or more additional UAVs. Alternatively, the one or more UAVs are different to the one or more additional UAVs.

Performing this method at the controller improves the operation of UAV wireless network monitoring. For example, initially determining irregularities based on lower level incidentally collected wireless network data allows for efficient use of UAVs as they may monitor more wireless networks in a shorter time and perform other tasks simultaneously. The use of baseline models allows automated scheduling of more detailed network monitoring where there is a likelihood of an irregularity/vulnerability in the network, these issues can then be remediated. When there is a lower likelihood determined the wireless network is not monitored at the higher levels of detail and so fewer resources are used to monitor wireless networks that do not require remediation. This saves on UAV mission time and battery life.

According to a second aspect of the present invention there is provided a controller of a plurality of Unmanned Aerial Vehicles, UAVs, configurable to receive wireless network data from one or more UAVs at a first level of detail; determine whether the wireless network data indicates an irregularity in a wireless network device; and in response to determining there is an indicated irregularity in the wireless network device, instruct one or more additional UAVs to collect wireless network data from the wireless network device at a second level of detail that is higher than the first level of detail.

According to a third aspect of the present invention there is provided an Unmanned Aerial Vehicle, UAV, configurable to incidentally collect wireless network data at a first level of detail; send the wireless network data to a controller; in response to receiving an instruction from the controller, collect wireless network data from the wireless network device at a second level of detail higher than the first level of detail; and send the wireless network data at the second level of detail to the controller.

Preferably the UAV is configured to receive updated route-planning data including a location of the wireless network device; and travel along a route based at least in part on the route-planning data.

According to a fourth aspect of the present invention there is provided a system comprising at least on UAV according to the third aspect and a controller according to the second aspect.

This summary is not intended to outline essential or key features. The summarised features are described further in the detailed description and may be included in any combination.

### BRIEF DESCRIPTION OF THE DRAWINGS

FIG. 1 is a schematic diagram of a UAV collecting wireless network data from a WAP.

FIG. 2 is a schematic diagram illustrating an example system for collecting wireless network data from UAVs to monitor wireless network devices.

FIG. 3 is a flow diagram illustrating a method for collecting wireless network data from UAVs to monitor wireless network devices.

FIG. 4 is a flow diagram illustrating an expanded method for collecting wireless network data from UAVs to monitor wireless network devices.

FIG. 5 is a flow diagram illustrating an extension to a method for collecting wireless network data from UAVs to monitor wireless network devices.

FIG. 6 is a schematic diagram of a UAV.

FIG. 7 is a schematic diagram of a Controller of a plurality of UAVs.

### DETAILED DESCRIPTION

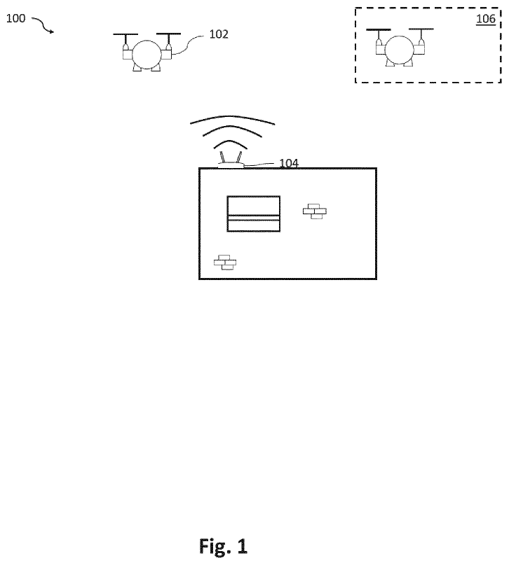

FIG. 1 is a schematic diagram illustrating a UAV passing by a wireless network device. Scene 100 includes a UAV 102 and a wireless network device 104 shown as a Wireless Access Point (WAP). The UAV 102 is in flight near a building containing the WAP 104. The building is any building such as a domestic home, an office, a commercial premises. The WAP 104 is active and generating signals associated with wireless networking. While shown as a WAP it could be any wireless network device capable of providing wireless network data for collection by the UAV 104, such as internet of things IoT devices, mobile base stations, Wide Area Network devices, etc. The UAV 102 is travelling within communication range of the WAP 104 and comprises network sensors for monitoring wireless communications. The wireless communication can be in any format detectable by the network sensors of the UAV 102 such as Wi-Fi, Bluetooth, 5G, etc. While shown as a single UAV it is to be understood that in practice the data may be collected by multiple UAVs.

The UAV 102 is travelling in a path dictated by a primary task such as a delivery or surveillance task. While travelling the UAV 102 incidentally collects network data from wireless network equipment within range, including the WAP 104. The monitoring incidentally performed by the UAV 102 includes data collection of wireless network data of a low detail. This allows the monitoring to be completed in the short period the UAV 102 is within range of the WAP 104 while travelling by. The monitoring may be performed intermittently or continuously as the UAV 102 follows its route. The UAV 102 may be any UAV that is configurable to carry and operate network sensors for wireless network data collection in flight. The composition of the UAV 102 and the types of network data collected are described in further detail in the paragraphs below.

The WAP 104 could have a vulnerability such as an undesired open port or misconfigured Domain Name Service (DNS). In some cases, the WAP is already compromised such as by being incorporated into a botnet system. Indications of these wireless network hazards are gained by analysing collected wireless network data, such as that collected by UAV 102. Monitoring wireless network devices using a UAV 102 is advantageous because it allows data collection from otherwise hard-to-reach wireless network devices. This monitoring can be more efficient as the UAV can collect wireless network data incidentally while carrying out a separate primary task. This further allows such wireless network devices to be monitored on a regular basis and in an untargeted manner.

Initial monitoring by the UAV 102 is at a low level of detail. This allows the UAV 102 to monitor while passing through the range of the WAP 104 without specifically targeting it and in a single pass. If the collected wireless network data from this initial monitoring indicates a potential irregularity in the wireless network device, then further monitoring by the same UAV 102 and/or an additional UAV/s 106 can be scheduled. Assigning multiple UAVs or passes by a same UAV to monitor an irregular wireless network device improves the likelihood of an accurate determination of a vulnerable or compromised WAP 104, or other type of wireless network device. Further monitoring also allows for collecting different types of wireless network data which achieves a more detailed and comprehensive picture of the device status. It has been found that by using a progressive operation, that is, progressively obtaining more data and carrying out more detailed analysis about a potentially compromised wireless device, it is possible to achieve an efficient and effective security monitoring process. Efficiency is gained since the progressive operation does not have to be carried out to its full extent for every UAV data collection event.

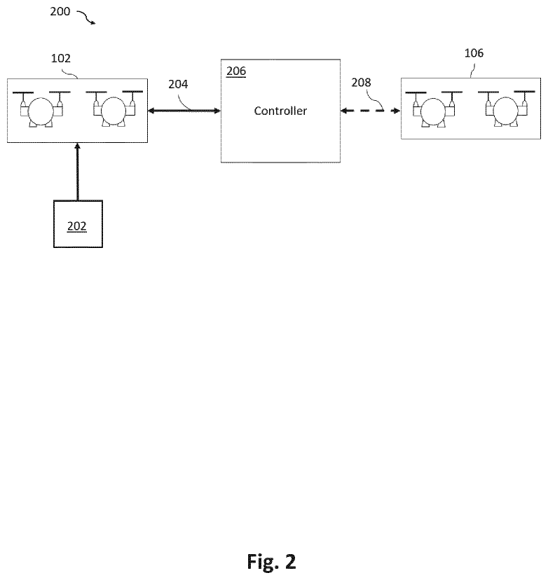

FIG. 2 is a schematic diagram of an example system for monitoring wireless networks using UAVs. The system comprises one or more UAVs 102 incidentally collecting network data 202, a Controller of a plurality of UAVs 206 and optionally one or more additional UAVs 106. The one or more UAVs 102 is linked through a wireless connection 204 to the Controller 206. The Controller 206 may also communicate wirelessly to a separate second UAV 106 through wireless connection 208. The controller is a communications network node such as a server, router, switch, or other communications network node suitable for communicating with and controlling UAVs. The controller comprises rules, logic, or other functionality for controlling the UAVs in order to control what data the UAVs collect, when the UAVs collect data and to control routes of the UAVs.

The UAV 102 carries network sensors that are configurable to collect wireless network data from devices in the local area of the UAV 102. This is performed when the UAV 102 is in flight allowing for data to be collected from local wireless networks while following a predetermined route for another task. The collection of wireless network data at this first level of detail is untargeted and does not include authentication or other substantial interaction with the wireless network devices it collects data on. An example first level of wireless network data collected is Radio Frequency (RF) spectrum level data of the wireless activity emitting from wireless network devices in the area. Collecting RF spectrum level data does not require pre-existing knowledge of local wireless network devices, nor the targeting of a specific wireless network device. It can also be collected in a short time and from a longer range than other wireless network data. The UAV 102 is therefore able to use the network sensors to collect the wireless network data while performing a separate primary task, such as delivery or surveillance. In some cases, the UAV 102 collects the wireless network data intermittently; that is, rather than constantly monitoring for wireless network data, the UAV 102 does so at intervals to save power, alternatively continuous collection may be preferred. Once wireless network data is detected the frequency of the intervals may be increased. While referred to as the UAV it is to be understood that data can be collected by multiple UAVs.

The UAV 102 forwards the collected wireless network data at the first level of detail 202 to the Controller 206 through the wireless connection 204. The UAV 102 includes network adapters and antennae to establish a link with the controller 206. The data is sent in packets using any communications protocol suitable for wireless data transfer such as transmission control protocol, internet protocol, unigram data protocol (TCP/IP or UDP).

The Controller 206 receives the wireless network data at the first level of detail 202 through the wireless connection 204. The controller 206 analyses the wireless network data to determine any indicated irregularities. An irregularity is identified by comparing with data from a baseline model expected for the wireless network data. Differences between the received network data and the baseline data over a threshold may indicate an irregularity in the wireless network data. The threshold is dynamically determined using empirical data or set during manufacture. Alternatively, an irregularity in the wireless network data is inferred directly using a trained classifier.

When an irregularity is indicated by the wireless network data 202 the Controller 206 initiates further investigation by instructing further monitoring in greater detail. This greater detail allows the Controller 206 to determine whether the irregularity is a result of a vulnerable or compromised wireless network device where remediation is required. Alternatively, the irregularity could be caused by a service problem. An example being a network service outage in which wireless network devices may increase their broadcast activity attempting to re-establish a connection. The irregularity may also be caused by random fluctuation of activity or user behaviour.

Accordingly, the Controller 206 provides instructions to collect wireless network data from the same wireless network device, or at a same location of the wireless network device, but now in greater detail. This includes either instructing the UAV 102 to make a return trip to the previous location to collect wireless network data in a second higher level of detail. Or an additional group of one or more UAVs 106 may be instructed to collect the wireless network data in the second level of detail.

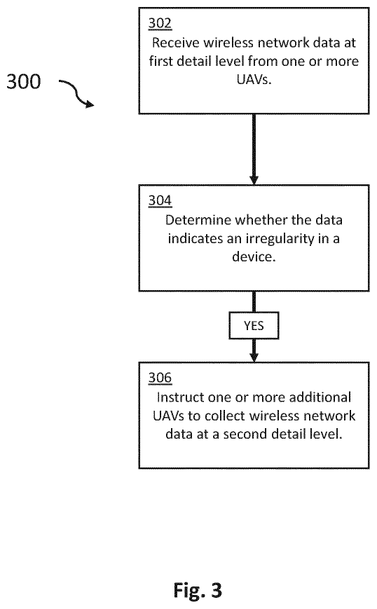

FIG. 3 illustrates a method 300, performed by the Controller of a plurality of UAVs 206, for instructing further collection of wireless network data from a wireless network device. The controller and UAVs of FIG. 3 may be the same as that of FIG. 2. At step 302 the Controller 206 receives wireless network data at a first level of detail from one or more UAVs. The network data having been collected by untargeted scanning as the UAV/s passed through the range of wireless network devices on a route dictated by a separate primary task. The network data includes any wireless network data that can be collected in flight over a short period, at range and without substantial interaction with wireless network devices. Examples include radio frequency (RF) data of the wireless activity and/or handshake session data with local wireless network devices.

At step 304, the Controller 206 determines whether the received network data indicates an irregularity in the wireless network. This determination may be made by comparing at least a part of the network data to a stored baseline model. The baseline model including data values that are representative of typical operation for a wireless network device. Alternatively, it is a specific baseline model for the wireless network device that has been generated from historical activity data for the wireless network device. The baseline model is accessible by the Controller and may be populated by wireless network data previously collected from the wireless network device over an extended period.

Where the received network data includes RF frequency data, this is compared to expected RF frequency data from the baseline model. RF frequency data determined to be different than the expected level by an amount more than a threshold indicates an irregularity. The Controller 206 may determine that wireless network data of greater detail is required to determine if the irregularity is itself indicative of a vulnerability in the wireless network device. Similarly, where the received network data includes handshake session data, responses and/or data from the handshake session are collected and received by the Controller 206. These are also compared to baseline expected responses and any differences can indicate an irregularity.

Alternatively, the received network data can be input to a trained classifier at the Controller 206. This may involve parsing the data from the received format into a required format for use by the classifier. The classifier having been trained to identify wireless network data that indicates irregularity or vulnerability using network data observed by UAVs from known vulnerable wireless networks. The classifier generates and outputs a likelihood that the wireless network data indicates a vulnerability of a wireless network device. A likelihood over a set threshold can be used by the Controller to determine that the wireless network data indicates an irregularity. Irregularity detection using the classifier provides greater accuracy but requires retraining for new emerging threats.

At step 306, the Controller 206 has determined that there is an irregularity indicated by the wireless network data. The Controller 206 now requires more detailed wireless network data to decide whether a vulnerability is present or if remedial action is needed; because the wireless network data at the first detail level while showing an irregularity, was untargeted and of too low resolution to make an accurate decision. The irregularity may still have been caused by a non-malicious cause such as a service outage or random activity fluctuation.

The Controller then instructs one or more additional UAVs to collect wireless network data from the wireless network device at a second level of detail. The instruction is sent out over a wireless connection between the Controller and the one or more additional UAVs. The one or more additional UAVs are either already in active operation or can be launched in response to the instruction.

The one or more additional UAVs could be the same as the one or more UAVs or a distinct second group of UAVs. In the case where the one or more additional UAVs are the same as the one or more UAVs the wireless network data at the second level of detail may be collected in a return trip from the destination of the primary task. The Controller may specifically select the one or more additional UAVs from a plurality of available UAVs to receive the instruction. The selection of UAVs as the one or more additional UAVs is based on considerations such as their current location, installed network sensors, battery level or any other consideration.

The one or more additional UAVs are configurable to collect wireless network data using wireless network sensors at the second level of detail. The second level of detail is higher than the first level and includes data collection that requires that a UAV spends a longer time within range of the wireless network device than the first level. The wireless network data at the second level of detail may include latency test data or configuration check data. Configuration check data further including DNS, DHCP, firewall configurations or any other configuration checks of the wireless network device.

Compared to wireless network data at the first detail level, that of the second detail level requires at least one of: a longer collection period, a shorter distance between the UAV and the wireless device, active interaction between the UAV and the wireless network device. For example, at the first level of detail, RF frequency data requires no active interaction with the wireless network device and can be performed rapidly from range. Whereas, at the second detail level, latency testing requires active interaction with the wireless network device and/or a longer period to collect the data. Where a longer period to collect the data is used the UAV has to hover in the vicinity of the wireless device which is expensive in battery life and operating cost. It is more efficient to collect data at this higher level of detail after an irregularity is already indicated by data at a lower level of detail. Because otherwise the time and level of interaction of this data collection would reduce the number of wireless network devices monitored in a first pass of the UAV and potentially disrupt other primary tasks being performed by the UAV. Once an irregularity is indicated though collecting at this second level of detail there is a clearer picture of the behaviour of the wireless network device and the controller is better able to identify indications of security vulnerabilities.

Method 300 provides an efficient process for monitoring wireless network devices. The untargeted first level of detail data collection allows UAVs to carry on with other primary tasks while still providing initial monitoring of network devices. This can then be escalated or progressed on detection of an irregularity to arrange for more detailed investigation by the same or additional UAVs.

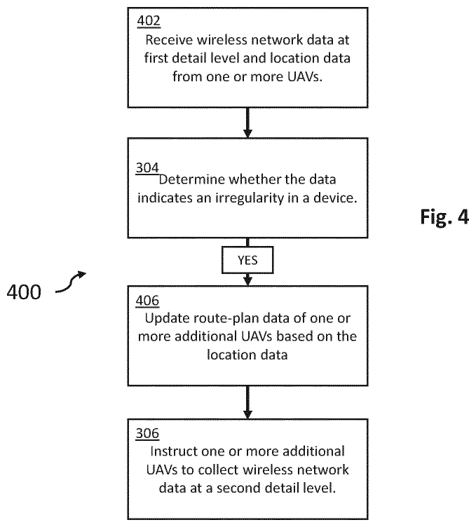

FIG. 4 illustrates an expanded method for instructing further monitoring of a wireless network device, performed by a Controller of a plurality of UAVs 206. In addition to steps 304, 306 and 308 from method 300, method 400 includes steps 402 and 406. In step 402 the controller receives the same wireless network data from one or more UAVs as described previously in the method 300. But additionally, the UAV also logs location data associated with the wireless network data and this is also received by the Controller with the wireless network data. The location data includes a location of the one or more UAVs when the wireless network data was collected, additionally or alternatively the location data includes a direct location of the wireless network device. The location data can be in any format suitable to be used by UAVs to navigate to a location. For example, global positioning system GPS, altitude, and/or longitude and latitude. In some cases the location data from the wireless network device is expressed using internet protocol address data, or wireless base station signal strength data. In these cases, the controller has mapping functionality to map the location data into a form suitable for controlling location of UAVs. Alternatively, satellite imaging and/or computer vision are used to establish the location.

At step 406 the Controller updates the route-planning data of one or more additional UAVs to include the location data. The route-planning data comprising at least one route for the additional UAVs to follow that includes the location. This is communicated to the one or more additional UAVs through a wireless connection from the Controller to the one or more additional UAVs. The Controller generates the route planning data using any route-planning algorithm suitable for directing UAVs and incorporating the received location data as a requirement. Examples including generating route-planning data using an A* path searching algorithm or applying contraction hierarchies.

The route-planning data allows the one or more additional UAVs to navigate autonomously to, or return to, the area where the wireless network data at the first level of detail was previously collected. By travelling along a route based at least in part on the route-planning data. Where the one or more additional UAVs are the same as the one or more UAVs the route may form part of a return route from a destination determined by the primary task. The one or more UAVs performed wireless network data collection at the first level of detail in an untargeted manner while passing over. However, the one or more additional UAVs through the route-planning data are routed purposefully within range of the location data where the irregularity was identified. This routing allows collection of wireless network data with more restrictive range, interactivity, and collection period requirements at this second and higher level of detail.

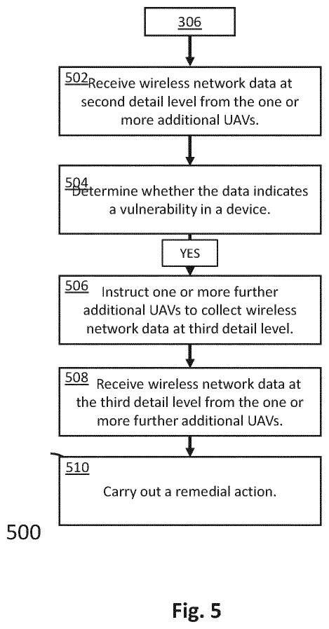

FIG. 5 illustrates an extension to the methods 300 and 400. At step 306 the one or more additional UAVs have been instructed to collect wireless network data at the second level of detail from the wireless network device. Now at step 502 this wireless network data is received at the Controller. It is received over a wireless connection from the one or more additional UAVs. As discussed above the wireless network data at the second level of detail is at a higher level of detail than the first level and may include latency test data and/or configuration check data. For example, the wireless data at the second level of detail may comprise DNS configuration data collected by the wireless network devices in the one or more additional UAVs.

At step 504 the Controller determines whether the wireless network data indicates a vulnerability in a wireless network. Vulnerabilities are more specific indications of a wireless network security issue than an irregularity, and so require wireless network data of the second higher level of detail to determine. The determination is carried out by a comparison to a baseline model and configuration. For example, where the wireless network data comprises DNS configuration data this is compared to expected DNS configuration data of a baseline model. Any anomalous differences may indicate the presence of a vulnerability at the wireless network device. A threshold level of difference may be used to decide whether a vulnerability is indicated from the wireless network data at the second level of detail. A difference to the baseline model data beyond the threshold level showing a high likelihood of a vulnerability. As with the irregularity identification, alternatively a trained classifier is used to determine whether the wireless network data at the second level of detail indicates a vulnerability in the wireless network device.

At step 506 the Controller has determined a vulnerability is indicated by the wireless data received. It then instructs one or more further additional UAVs to collect wireless network data from the wireless network device at a third level of detail. The one or more further additional UAVs may be a different group of UAVs to the one or more UAVs and the one or more additional UAVs or the same group. Selection of the one or more further additional UAVs is based on a consideration of the available UAVs under control of the controller such as: current location, installed network sensors, battery level or any other consideration. For example, a specific active UAV may only have network sensors capable of collecting the wireless network data at one of the first, second and third level of details. Accordingly, the controller selects an appropriate UAV for the required level of detail for collection. This selection allows the plurality of UAVs to be utilised efficiently.

The third level of detail is higher than the first and the second level of detail. The wireless network data collected at this level of detail is targeted specifically at the wireless network device at which a vulnerability is indicated. The wireless network data collection process uses two-way interaction with the wireless network device such as for example authentication with the wireless network device. As well as potentially using longer collection periods and shorter ranges than the wireless network data at the first and second levels to collect. The wireless network data at the third level of detail can include port scan data from an installed port scanner and/or Common Vulnerabilities and Exploits (CVE) detection data.

A port scanner is a computer program that checks network ports for one of three possible statuses—open, closed, or filtered. Port scanners are valuable tools in diagnosing network and connectivity issues. However, attackers use port scanners to detect possible access points for infiltration and to identify what kinds of devices you are running on the network, like firewalls, proxy servers or VPN servers.

Instructing the UAV comprises sending an instruction message over a wireless connection to the one or more further additional UAVs. The message includes the instruction to collect data at the third level and potentially the location data associated with the wireless network device. While not shown the Controller may also update the route-planning data of the one or more further additional UAVs. Route-planning may include direct routing towards the wireless network device without consideration of other tasks being conducted, due to the indication of a potentially serious vulnerability the UAV.

At step 508 the Controller receives the wireless network data at the third level of detail from the one or more further additional UAVs. The data is received over the wireless connection between the one or more further additional UAVs and the Controller. The data is received in packets using any communications protocol suitable for wireless data transfer such as TCP/IP or UDP.

At step 510 the Controller has determined in which way the wireless network device is vulnerable and/or compromised, by analysing the wireless network data at the third level of detail. This may be done using the baseline model or trained classifier. The Controller then proceeds to implement remedial actions to address the issue. If the Controller can communicate with the wireless network device, then remedial action can be enforced through direct communication. This may include sending instructions to the wireless device to trigger implementation of security protective measures, a reconfiguration of the wireless network device, a classification of the wireless network device into a vulnerable state, or any other direct method of security improvement. The instructions are sent from the controller to the wireless device via the UAV or directly from the controller to the UAV.

Additionally, or where there is no direct communication with the wireless network device the remedial actions can include messaging a user or security team with a warning, recommendation for disaster recovery equipment such as a replacement wireless network device, or other indirect remedies.

It is to be understood that any of the methods outlined above can be implemented in hardware, firmware, or software. Additionally, the methods can be implemented in any combination of hardware, firmware, or software.

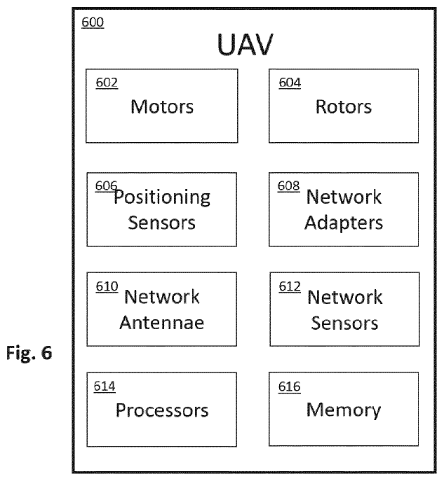

FIG. 6 is a schematic diagram showing the components of a UAV 600. The UAV 600 a first, second and/or third UAV according to the methods described above. The UAV 600 is configurable to travel in a route based on route-planning data, collect wireless network data in at least one of a first, second and third level of detail, and to send wireless network data to a Controller.

The UAV 600 includes motors 602, rotors 604, and positioning sensors 606 to power and navigate the UAV 600 for flight to the required locations. The positioning sensors 606 generate location data which may be communicated to the Controller to arrange further monitoring of the wireless network device. A processor 614 is configurable to utilise route-planning data stored in memory 616 to navigate the UAV 600 in flight.

The UAV 600 also includes network adapters 608 and network antennae 610 to establish a wireless connection with the Controller. The network adapters 608 includes any wireless technology for communication between base stations and UAVs such as Wide Area Networks (WANs) or 5^{th} Generation cellular networks. The network adapters are configurable to send the wireless network data across the wireless connection and to receive instructions from the Controller. As well as any data transfers required for other tasks to be performed by the UAV. Network sensors 612 include sensors to collect the wireless network data at the first, second and/or third levels of detail. For example, port scan data of a wireless network can be collected by a port scanning sensor of the UAV 600.

Processors 614 of the UAV 600 control the components of the UAV according to instructions stored on the memory 616 or received at the network adapters 608. This includes controlling the motors 602, the rotors 604, the positioning sensors 606, the network adapters 608, and the network sensors 612 of the UAV 600. The memory 616 is also used to store the location data, received instructions, wireless network data and any other data required. While the processors 614 are shown as a single component they may include several processors operating in parallel.

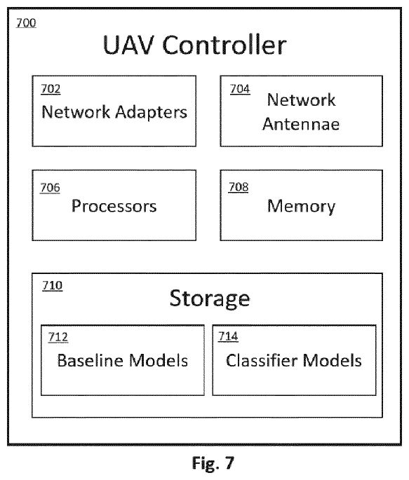

FIG. 7 is a schematic diagram showing the components of a Controller 700. The Controller comprises network adapters 702, network antennae 704, one or more processors 706, memory 708, and storage 710. While only one Controller is shown this may be a distributed system comprising multiple separate controllers working in parallel.

The network adapters 702 are configurable to wirelessly communicate with one or more UAVs. The network adapters may use wide area network (WAN) technology, 5G technology, or any other wireless connectivity to communicate with UAVs. Through the network adapters 702 wireless network data is received from the UAVs and instructions are sent from the Controller to the UAVs as described in the methods above. The wireless antennae transmit and receive messages and are controlled by the wireless adapters 702.

The processors 706 includes one or more processors of the Controller 700. They control the components of the Controller according to instructions stored on the memory 708. This includes controlling the network adapters 702 and the storage 710. The memory 708 is also used to store the received location data, received wireless network data, and any other data required. While the processors 706 are shown as a single component they may include several processors operating in parallel. Further the processing for the Controller may be carried out in a distributed manner such as in a cloud or data center system.

Storage 710 includes two sets of stored models, baseline models 712 and classifier models 714. The baseline models include baseline model data for wireless network data at any of the first, second or third level of detail. The classifier models include stored classifier models configurable to identify a likelihood of irregularities and/or vulnerabilities in wireless data at any of the first, second and third detail level.

1. A method performed by a controller of a plurality of Unmanned Aerial Vehicles, UAVs, for performing wireless network monitoring the method comprising:
receiving wireless network data from one or more UAVs at a first level of detail;
determining whether the wireless network data indicates an irregularity in a wireless network device; and
in response to determining there is an indicated irregularity in the wireless network device, instructing one or more additional UAVs to collect wireless network data from the wireless network device at a second level of detail that is higher than the first level of detail.

2. The method according to claim 1, wherein receiving wireless network data further comprises receiving from the one or more UAVs a location of the wireless network device, and
wherein instructing the one or more additional UAVs to collect wireless network data at the second level of detail from the wireless network device further comprises updating route-planning of the one or more additional UAVs to include the location.

3. The method according to claim 1, wherein the wireless network data at the first level of detail comprises one or more of: RF frequency data and handshake session data.

4. The method according to claim 1, wherein the wireless network data at the second level of detail comprises one or more of: latency test data and configuration check data.

5. The method according to claim 1, wherein the wireless network data at the second level of detail comprises configuration check data comprising one or more of Domain Name Service, DNS, Dynamic Host Configuration Protocol, DHCP, and firewall check data.

6. The method according to claim 1 further comprising:
receiving from the one or more additional UAVs the wireless network data at the second level of detail;
determining whether the wireless network data at the second level of detail indicates a vulnerability in the wireless network device; and
in response to determining there is an indicated vulnerability in the wireless network, instructing one or more further additional UAVs to collect wireless network data from the wireless network device at a third level of detail that is higher than the first and second level of detail,
the wireless network data at the third level of detail comprising at least one of port scan data and Common Vulnerabilities Exploits, CVE, detection data.

7. The method according to claim 1 further comprising receiving from the one or more further additional UAVs the wireless network data at the third level of detail; and
communicating with the wireless network device to take remedial action based at least in part on the wireless network data at the third level of detail.

8. The method according to claim 1 further comprising:
retrieving a baseline model for the wireless network data; and wherein
the determining whether the wireless network data indicates an irregularity in the wireless network device comprises comparing the wireless network data at the first level of detail to the baseline model for the wireless network data.

9. The method according to claim 1 wherein determining whether the wireless network data indicates an irregularity in the wireless network device comprises classifying the wireless network data using a trained classifier;
the classifier being trained using examples, previously collected using at least one UAV, of wireless network data from known vulnerable wireless network devices; and
the classifier generating a likelihood that the wireless network device is vulnerable.

10. The method according to claim 1 wherein the one or more UAVs are the same as the one or more additional UAVs.

11. The method according to claim 1 wherein the one or more UAVs are different to the one or more additional UAVs.

12. A controller of a plurality of Unmanned Aerial Vehicles, UAVs, configured to:
receive wireless network data from one or more UAVs at a first level of detail;
determine whether the wireless network data indicates an irregularity in a wireless network device; and
in response to determining there is an indicated irregularity in the wireless network device, instruct one or more additional UAVs to collect wireless network data from the wireless network device at a second level of detail that is higher than the first level of detail.

13. An Unmanned Aerial Vehicle, UAV, configured to:
incidentally collect wireless network data at a first level of detail;
send the wireless network data to a controller;
in response to receiving an instruction from the controller, collect wireless network data from the wireless network device at a second level of detail higher than the first level of detail; and
send the wireless network data at the second level of detail to the controller.

14. The UAV according to claim 13 further configured to:
receive updated route-planning data including a location of the wireless network device; and
travel along a route based at least in part on the route-planning data.

15. A system comprising:
at least one UAV according to claim 13; and
a controller.
